(19) United States
(12) Patent Application Publication
(10) Pub. No.: US 2012/0133782 A1
(43) Pub. Date: May 31, 2012

(54) Interactive Image Activation And Distribution System And Associated Methods

(76) Inventor: Clifford R. David, New York, NY (US)

(21) Appl. No.: 13/299,679

(22) Filed: Nov. 18, 2011

Related U.S. Application Data
(63) Continuation-in-part of application No. 11/854,605, filed on Sep. 13, 2007.
Application No. 11/854,605 is a continuation-in-part of application No. 11/691,583, filed on Mar. 27, 2007, now Pat. No. 7,966,223.
Application No. 11/691,583 is a continuation-in-part of application No. 11/279,642, filed on Apr. 13, 2006, now Pat. No. 7,881,968.
(60) Provisional application No. 61/415,026, filed on Nov. 18, 2010.
(60) Provisional application No. 60/671,928, filed on Apr. 15, 2005.

(51) Int. Cl. H04N 5/225

(52) U.S. Cl. 348/207.1; 348/E05.024

(57) ABSTRACT

A method for distributing a digital image of a customer includes receiving a request from a customer to a human representative (i.e., a “roving” photographer) for an image to be taken of the customer at a site. An image of the customer is captured by the “roving” photographer at the site in response to the received request. The image is transmitted to a remote processor. An electronic request is received from the customer to view the transmitted image, and the image is transmitted from the remote processor to the customer's communication device. If the customer decides to purchase the image, a transaction is finalized by receiving payment data from the customer, and the final image is provided to the customer. A commission is then paid to the photographer for the transaction. The cost may be subsidized by advertisement pushed to the customer's communication device.

### CROSS-REFERENCE TO RELATED APPLICATION

This application claims priority to U.S. Provisional Patent Application Ser. No. 61/415,026, filed Nov. 18, 2010, and is also a continuation-in-part of application Ser. No. 11/854,605, filed Sep. 13, 2007, which itself is a continuation-in-part of application Ser. No. 11/691,583, filed Mar. 27, 2007, which itself is a continuation-in-part of application Ser. No. 11/279,642, filed Apr. 13, 2006, which itself claimed priority to Provisional Application Ser. No. 60/671,928, filed on Apr. 15, 2005, the disclosures of which are herein incorporated by reference in their entirety, and all commonly owned.

### FIELD OF INVENTION

The present invention generally relates to photographing systems and methods, and, in particular, to such systems and methods for ordering, activating, and distributing digital images to a customer.

### BACKGROUND

The sale of photographs taken by a photographer of a customer of, for example, a theme park, cruise, or other event where there are large volumes of people present is known in the art. This system has inherent inefficiencies, in that the photographer typically prints many more photographs than are ultimately sold, and the sale is dependent upon the customer's viewing and agreeing to purchase the photograph displayed after the event, thereby losing any momentum caused by the excitement of the moment.

An additional problem with known systems is that panoramic photographic images, which may comprise, for example, stills or videos, are typically not possible when taken by a photographer close to the customer, nor images taken from a distance or height. Further, a customer may desire a photograph to be taken at a time when a photographer is not in the vicinity.

Another particular difficulty with photography in general is that there is no really viable system available wherein the photographer can be in the picture. Personal camera equipment is typically not sufficiently sophisticated to produce a good product, and extra equipment, such as tripods, must be hauled along to accomplish self-photos. In the realm of videography, there is no known way to film oneself wherein the camera moves. Further, the skill of the individual is typically lacking, and good amateur photographs are rare.

An additional difficulty at present is that there is no known way for a professional photographer to photograph a person at a location and distribute to many people simultaneously and contemporaneously for a fee, the photograph being of much higher quality than would be possible using, for example, a cellular telephone or other such device.

Therefore, it would be desirable to provide systems and methods for more efficiently capturing and delivering photographic and/or video images to a customer on demand, with the capability of remote ordering and payment, in some embodiments upon viewing a preview of the image with the use of a personal communication device. It would also be desirable to provide systems and methods wherein the customer can be a subject of the image. It would be additionally desirable to provide systems and methods for distributing images simultaneously and contemporaneously many people other than the image subject as well as to the image subject him/herself.

### SUMMARY OF THE INVENTION

The present invention in one aspect is directed to a method for distributing a digital image of a customer. The method may comprise receiving a request from a customer for an image to be taken of the customer at a site. The request may be received, for example, via a remote signal from a customer's communication device. Payment data may be obtained from the customer, and a location of the site determined.

The request is relayed to a remote imaging device that is positioned to image the customer at the site. An image of the customer is automatically captured at the site, and the image is relayed as a proof image to the customer's communication device. Finally, if the image is desired by the customer, an approval is received from the customer to purchase the image.

In another aspect of the invention, a method for distributing a digital image of a customer may comprise relaying a request from a customer to a human representative for an image to be taken of the customer at a site. Payment data are obtained from the customer, and a location of the site determined. A command is received at a remote imaging device to image the customer at the site, and an image is automatically captured of customer at the site.

A further aspect of the invention is directed to a system for distributing a digital image of a customer. In this embodiment the system may comprise a customer data receiver for receiving a request from a customer for an image to be taken of the customer at a site. The request is receivable via a signal from a customer's communication device. The receiver is also provided for obtaining payment data from the customer.

Means are provided for determining a location of the site. A remote imaging device is positioned to image the customer at the site and includes a receiver. A transmitter is in signal communication with the customer data receiver, the location determining means, and the remote imaging device receiver. The transmitter is useful for relaying the request to the remote imaging device and for signaling the remote imaging device to automatically capture an image of the customer at the site.

An image transmitter is in signal communication with the remote imaging device and is adapted to relay the image as a proof image to the customer's communication device. The customer data receiver is further adapted to receive an approval from the customer to purchase the image.

Another aspect of the present invention is directed to a system for distributing a digital image of a customer. The system comprises a representative communication device for receiving a request from a customer for an image to be taken of the customer at a site. The request is receivable via a signal from a customer communication device to a human representative. The representative communication device is also useful for obtaining payment data from the customer.

Means are provided for determining a location of the site. A remote imaging device is positioned to image the customer at the site and includes a receiver. A transmitter is in signal communication with the representative communication device, the location determining means, and the remote imaging device receiver. The transmitter is useful for relaying the request to the remote imaging device and for signaling the remote imaging device to automatically capture an image of the customer at the site.

An additional aspect of the invention is directed to a method for distributing a digital image of a customer. This embodiment comprises the step of receiving a request from a customer to a human representative (a “roving” photographer, by way of example) for an image to be taken of the customer at a site. An image of the customer is captured by the roving photographer at the site in response to the received request. The image is transmitted to a remote processor. An electronic request is received from the customer to view the transmitted image, and the image is transmitted from the remote processor to the customer's communication device.

If the customer decides to purchase the image, a transaction is finalized by receiving payment data from the customer, and the final image is provided to the customer. A commission is then paid to the photographer for the transaction.

In another embodiment, the transaction is at least partially subsidized by an advertisement that is sent to the customer's communication device.

### BRIEF DESCRIPTION OF THE DRAWING

The features that characterize the invention, both as to organization and method of operation, together with further objects and advantages thereof, will be better understood from the following description used in conjunction with the accompanying drawing. It is to be expressly understood that any drawing is for the purpose of illustration and description and is not intended as a definition of the limits of the invention. These and other objects attained, and advantages offered, by the present invention will become more fully apparent as the description that now follows is read in conjunction with the accompanying drawings, wherein

FIGS. 1A-1B provide a flowchart of exemplary methods of the present invention for providing an image to a customer;

FIG. 2 is a system schematic of the embodiment of FIG. 1;

FIG. 3 is a flowchart for an embodiment of the invention for use at a stadium;

FIG. 4 is a system schematic of the method of FIG. 3;

FIG. 5 is a flowchart for an embodiment of the invention for use when the customer is in motion;

FIG. 6 is a system schematic of the method of FIG. 5;

FIG. 7 is a flowchart for an embodiment of the invention for use when the customer is in a conveyance;

FIG. 8 is a system schematic of the method of FIG. 7;

FIG. 9 is a flowchart for an embodiment of the invention for use with a “roving” photographer;

FIG. 10 is a system schematic for the method of FIG. 9;

FIGS. 11A-B is a flowchart for another embodiment of the invention with a “roving” photographer;

FIG. 12 is a system schematic for the method of FIG. 11;

FIG. 13 is a flowchart for a transmission method of an embodiment of the invention;

FIG. 14 is a flowchart for another embodiment of the invention for an event; and

FIG. 15 is a system schematic for the method of FIG. 14.

### DETAILED DESCRIPTION OF PREFERRED EMBODIMENTS

The present invention will now be described more fully hereinafter with reference to the accompanying drawings, in which alternate embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

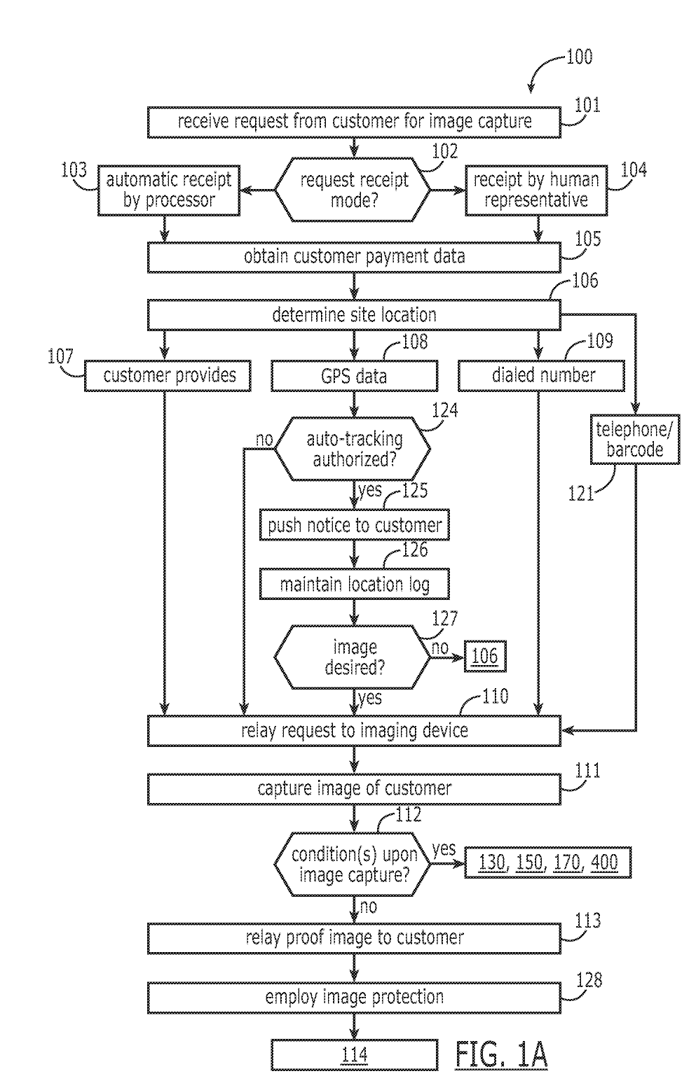

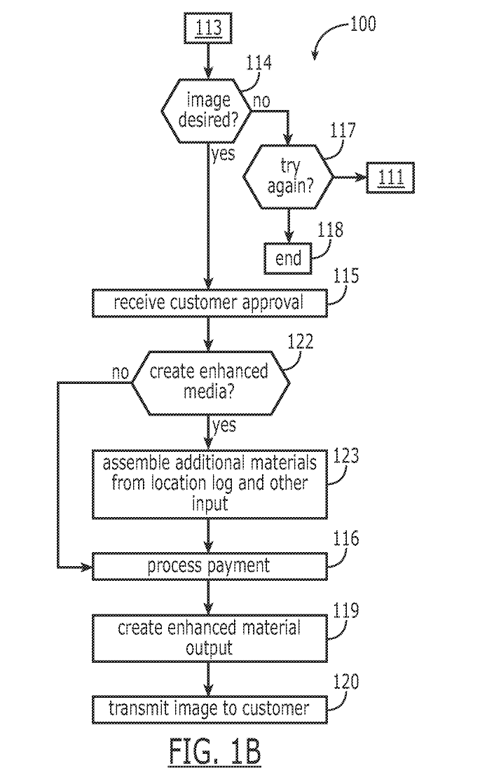

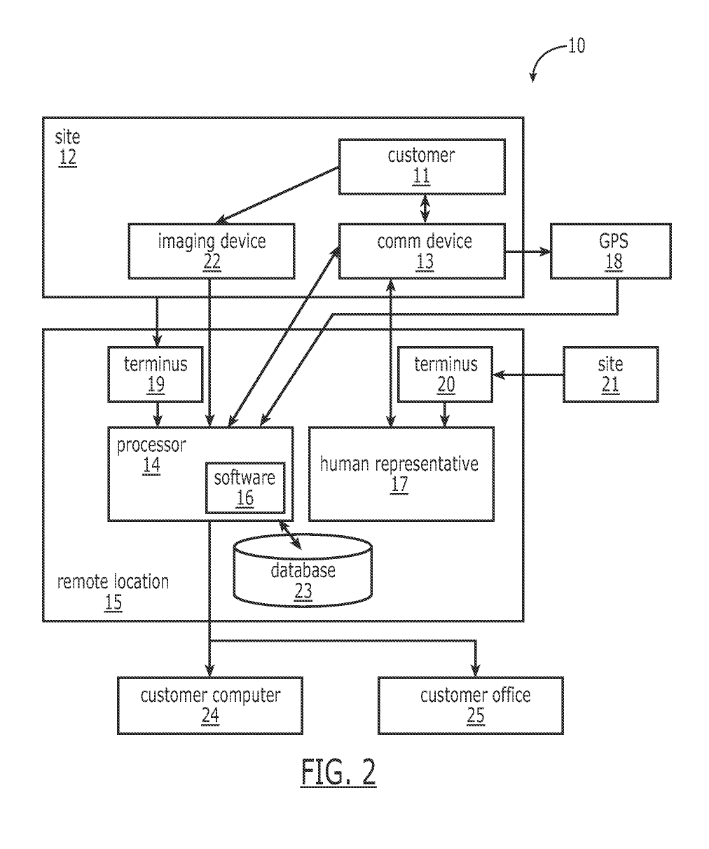

With reference initially to FIGS. 1A, 1B and 2, the present invention in one aspect is directed to a system 10 and method 100 for distributing a digital image of a customer. The method 100 comprises the step of receiving a request from a customer 11 for an image to be taken of the customer at a site 12 (block 101). The request can be received, for example, via a remote signal from a customer's communication device 13, for example, a cellular telephone, computer, or personal data assistant. Images may be captured continuously or on a predetermined basis, such as when the unit or ride stops or slows within the experience, or as may be signaled by a device or character, such as a clown or other interactive character. One of skill in the art will appreciate that any of a plurality of communication devices, known now or available in the future, can be used with the present invention, and use of the word “telephone” herein is not intended as a limitation on the invention.

Two exemplary embodiments are centered about the mode of receiving the request from the customer 11 (block 102). In one embodiment, the request is received and processed automatically with the use of a processor 14 at a remote location 15 and mediated by software 16 for carrying out the processor method steps (block 103). In this embodiment, the data can be transmitted from the customer 11 using the communication device 13 in ways known in the art, such as, but not intended to be limited to, voice recognition, keystroke entry, or tablet handwriting recognition.

Another mode of receiving the request comprises establishing a human representative 17 at the remote location 15. In this mode, the customer's request is received by the human representative 17 for an image to be taken of the customer 11 at a site 12 (block 104).

In either data-receipt mode, payment data are obtained from the customer (block 105), and a location of the site is determined (block 106).

There is a plurality of methods of determining the location of the site, as will be appreciated by one of skill in the art. For example, the site location determining step can be accomplished by directly receiving information on the site location from the customer (block 107), such as by asking for an oral or keypad indicator of location. In a theme park, for example, various “photo-rich” sites could be established and labeled as such, with indicia adjacent the site indicative of the site location. In a non-contained environment, such as a city, a printed or recorded travel guide could be provided to the customer prior to arrival with sights to see, each having an identifier associated therewith (“If you are at the Eiffel Tower, press 506.”). The travel guide could, for example, be provided over the Internet, and could include pictures of the sights and the associated photo-rich sites to enable the customer to find them easily. Such a travel guide could be provided at a contained environment as well, such as at entry. Obtaining the travel guide could be interactive, with selections enabled to tailor for customer interests (e.g., museums, panoramic views, animals, etc.). The travel guide could also be provided on site via the customer's communication device, which could operate similar to such devices as known for use at museums, wherein a depressing of a number on the device's keypad can produce a lecture on the site being visited (“For information on the Eiffel Tower, please press 507.”).

Another method of site location determination comprises electronically determining the site location from position data automatically ascertained from the customer's communication device 13 (block 108). This method can be accomplished, for example, using global positioning system 18 data obtained from a position of the communication device 13. Similarly, a site may have located therein a sending device that, when initiated from a receiver that is ready for this purpose, a message is sent to the customer's communication device 13 that they are in a location equipped with an imaging device 22 and that a photo opportunity is available.

In an embodiment wherein a form of tracking is used, the customer 11 authorizes the system 10 to track the customer's location by means of the communication device 13 (block 124). This may be accomplished by means known in the art, such as, but not intended to be limited to, GPS tracking or a check-in application such as FourSquare. The system 10 senses when the communication device 13 is at an imaging site 12 and “pushes” a notice to the communication device 13 to the customer 11 to that effect (block 125), and also maintains a log of the locations visited by the customer 11 (block 126). Alternatively, the customer 11 can “check in” at the location with the use of the communication device 13. If the customer 11 desires an image at that location (block 127), the method 100 proceeds to block 110, as will be described in the following; otherwise, the customer 11 is continued to be tracked (block 106). Yet a further method of site location determination is accomplished with the use of a characteristic of the remote signal (block 109). One method of accomplishing this can be wherein the remote signal comprises an electronic contact initiated to one of a plurality of termini 19, 20, the particular terminus contacted determinative of the site location. Thus a unitary processor 14 could be used to receive requests from a plurality of site locations 12,21, with a different telephone number provided for each site location 12,21, the dialed number data determinative of the particular site location 12 at which the customer 11 is currently positioned.

An additional method of site location determination is accomplished with the use of the customer's camera telephone (block 121). In this method, when the customer arrives at a photo spot, along with a sponsor logo is provided indicia, such as a barcode. The indicia can be photographed by the customer with a camera feature on a telephone 13. The software 16 receives the indicia and the calling telephone number via caller ID, identifies the customer via caller ID and the site from decoding the indicia. The customer is sent a text message with a link to activate the site camera 22, and also provides any other information relating to that site. There may be provided a count-down feature with a display to permit the customer to pose for the photograph. The image is then captured, and the photograph is sent to the customer's telephone 13.

In any of the request modes, the request is relayed to a remote imaging device 22 that is positioned to image the customer 11 at the site 12 (block 110). The imaging device 22, which may comprise, for example, a digital still or video camera, can be affixed, for example, in positions from which it would be difficult for the customer 11 to obtain an image him/herself, with or without other members of a group, such as from a great height or to provide a wide view.

An image is automatically captured of the customer 11 at the site 12 (block 111). This automatic capturing can be subject to certain predetermined conditions (block 112), as will be expanded upon further in the following, or can be substantially instantaneous, which is the case to be considered at present. Under “substantially instantaneous” is intended to be subsumed the possibility that the customer 11 could order an image from his/her communication device 13, and a “countdown” is issued over the communication device 13 so that the customer 11 can be adequately prepared in position for the image to be taken.

In one embodiment, the image can relayed as a proof image to the customer's communication device 13 or to another viewing device such as known in the art (block 113). Preferably this image will be of low resolution or having some marking or defect purposely imposed thereon to prevent the customer 13 from merely taking this image without making payment, and may have a feature of vanishing after a predetermined time. The proof image may also comprise a “preview” image that is captured prior to final image capture. In order to prevent the customer 11 from “stealing” the image without providing payment, one of a number of strategies may be employed (block 128). For example, the image could be imbedded in a script or video, with a countdown clock displayed, having approximately the same size as the image, and, perhaps, alternating with the image, which then could not be “grabbed” by the customer 11 but would permit viewing for a brief time. At the end of the countdown the image could disappear, and only the purchase option screen would be available.

If the image is desired by the customer (block 114), an approval is received from the customer 11 to purchase the image (block 115), and payment is processed (block 116). If the customer 11 declines to purchase the image (block 114), another attempt may be made to capture an image (block 117), or the method may end (block 118).

Further, a code could be sent to the customer's telephone 13 to enable a print device to fulfill a print order placed by the customer 11 over the telephone 13 after receipt of the image. Alternatively, the photo site could be provided with a scanner that could read indicia lodged on the telephone 13 to identify the customer 11 and enable an automated image-capture process.

As will be understood by one of skill in the art, the term “image” can include multiple forms, such as a digital still photograph or a video, and multiple imaging devices of multiple types and number can be situated at a particular location. The customer 11 can decide, upon agreeing to purchase the image (block 115), to include other features in the image, for example, but not intended to be limited to, an enhanced media output (block 122) that can comprise an enhanced image, such as achieved by editing the image to improve quality or adding indicia to the image. Further, a still image may comprise a plurality of images, and the customer may elect to purchase a collection of the plurality images as, for example, in a photo album. Additionally, the images may also include previously captured images of the site that are stored in the system and are not customer-specific, but may include, for example, panoramic views of a building or scenery, or views at different times of the day or season. Verbiage such as a travelogue may be added to such an album, gleaned from the locations that have been visited by the customer as stored in the location log at block 126. Such manipulation and creation can be carried out under control of the processor 14 and software 15, with previously stored verbiage and images accessible in a database 23 accessible by the processor 14.

In the case of a video, the manipulation can take the form of adding audio and video data to the video, which could include previously created audio and video data relating to the site location or audio data transmitted by the customer 11, for example, via the communication device 13. As with the photo album discussed above, an entire record of a trip or portions thereof can be created from a combination of customer-specific video and audio sections and prerecorded video and audio material to result in a professional-quality “movie,” starring the customer. The audio provided by the customer can be, for example, a combination of ad libbed material and pre-written “script” material provided by the system purveyor.

Once payment is processed (block 116), the enhanced media output can be created (block 119)

Whatever form the final output takes, upon completion, the purchased item is transmitted or made accessible to the customer 11 (block 120). Exemplary forms include, but are not intended to be limited to, a hard copy (printed photograph, video, DVD, etc.) that can be sent to a predetermined location, a digital image can be electronically routed to a predetermined electronic address such as a computer 24 at the customer's residence or office 25, and an electronic address can be provided for securing a digital image therefrom, for example, web-site accessibility for download to a device such as a personal media device, telephone or other viewing device.

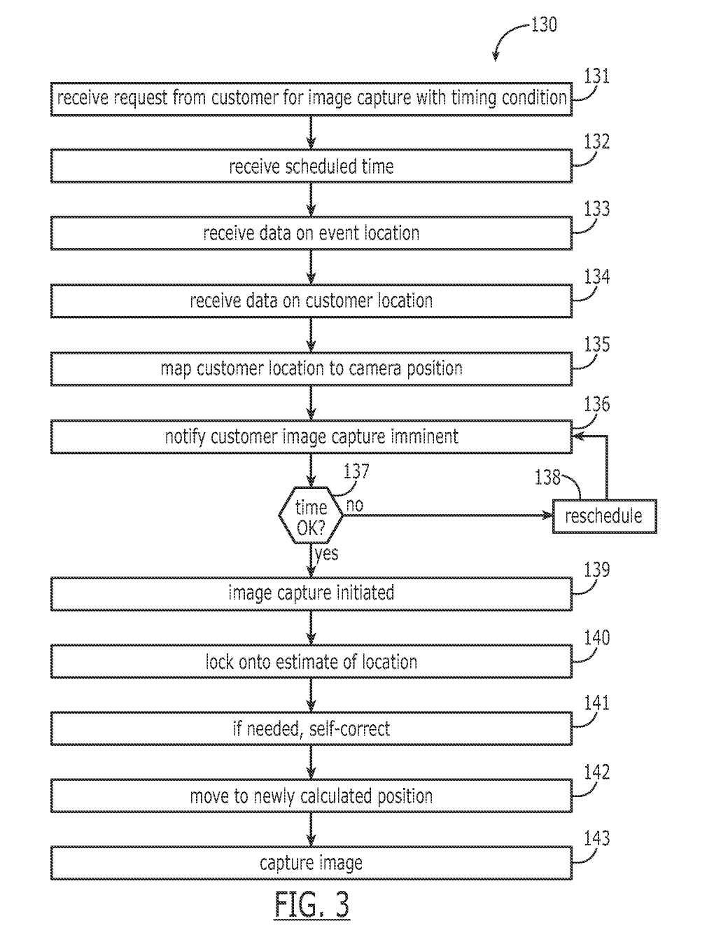

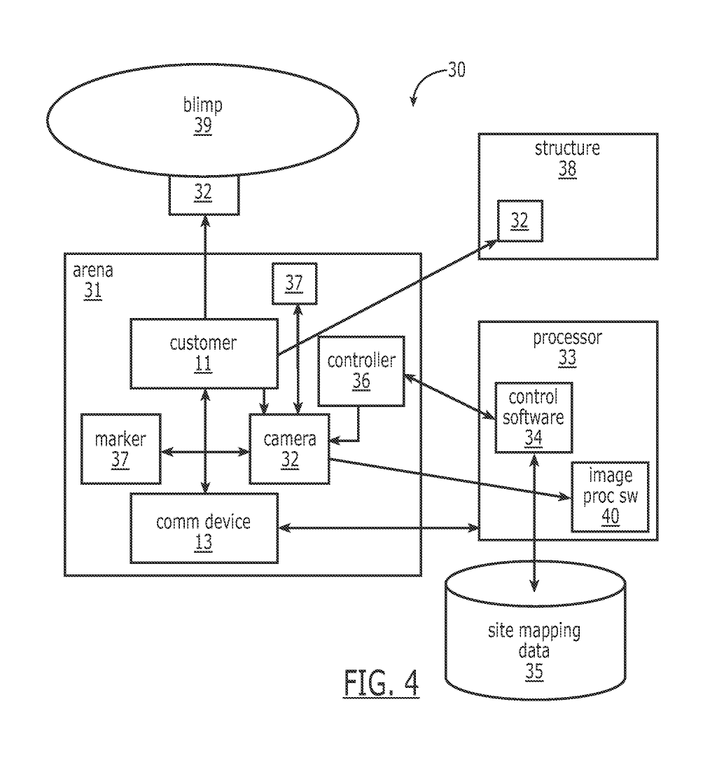

As mentioned above, in certain embodiments of the method 130, conditions can be put on the image capturing process when the customer 11 places an order (block 131; block 112, FIG. 1A). Some conditions may concern timing, so that the image is scheduled to be taken at a time stipulated in the timing condition (block 132), as in the embodiment depicted in FIGS. 3 and 4. Here the system 30 is installed for use in an enclosed, subdivided space such as a sports arena 31. In some ordering situations, if the customer uses a communication device 13 that is known to the system 30, and is identifiable via, for example, a caller ID-type function, the customer's previously stored data can be accessed. Such previously stored data may include such items as name, billing information, and season ticket data for correlating with likelihood that the customer is attending a particular arena event, and for accessing location information.

The system 30 comprises an imaging device 32 that is in signal communication with a processor 33, which may be situated at the arena 31 or remote therefrom. For example, the imaging device 32 could be situated off-site from the event, such as on a structure 38 outside the arena property or in the air on a blimp 39. The processor 33 has resident thereon control software 34, and site mapping data 35 are accessible by the software 34. The imaging device 32 is mounted so as to be movable responsive to the control software 34 to enable imaging the customer at a particular sub-area of the site 31.

In practice, once the customer 11 has placed an order (block 131) for an image to be captured, with additional data provided as to a particular event (time/place; block 133), the customer's exact location is requested, for example, as indicated by a seat number in the arena 31 (block 134). The seat location is then mapped by the software 34 to control parameters for the imaging device 32 (block 135), and, at the predetermined time, the customer 11 can be notified, such as via the communication device 13, that an image is about to be captured (block 136). If the present time is not acceptable (block 137), the capture can be rescheduled (block 138); otherwise, the confirmation results in the image capture process being initiated (block 139).

As part of the image capture process is included a feature for ensuring that the imaging device 32 be aimed correctly. As will be understood by one of skill in the art, whatever mechanism 36 is used to point the imaging device 32, there is likely to be inherent drift and resulting inaccuracies in positioning. In order to correct for such imprecision, preferably the system 30 further comprises a marking standard 37, and preferably a plurality of marking standards 37, positioned around the arena 31. Using techniques known in the art of image processing, software 40 resident on the processor 33 first locks in on the marking standard 37 believed to be closest to the customer 11 (block 140) and performs a self-correction algorithm to inform the mapping and control software 34 (block 141). The imaging device 32 is then moved under control of the control software 34 to the newly calculated position (block 142), and the image is captured (block 143). The remaining processing and transmitting steps can be substantially as discussed above.

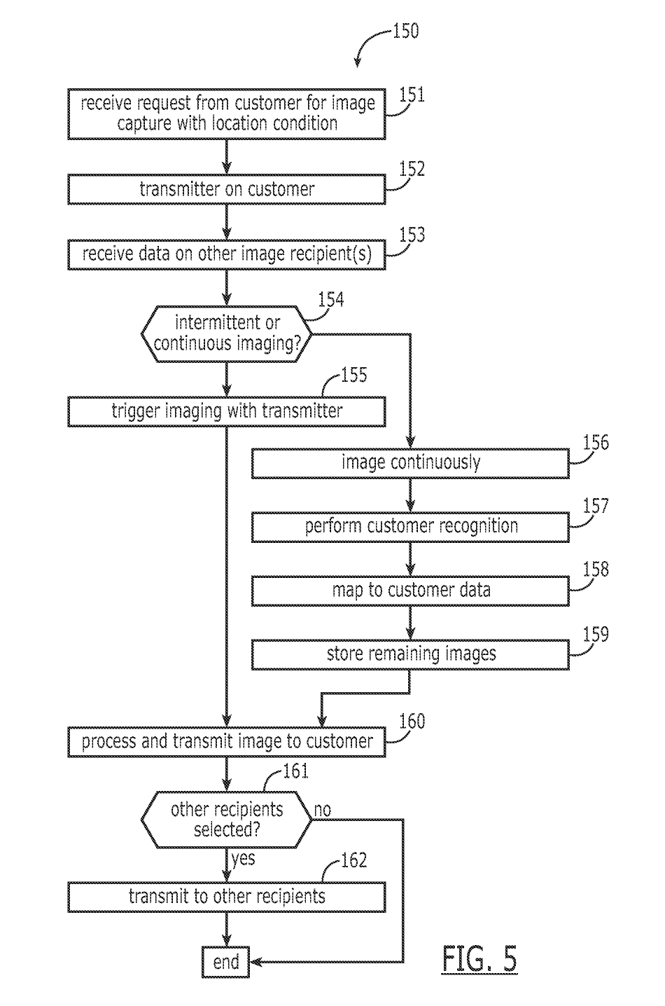

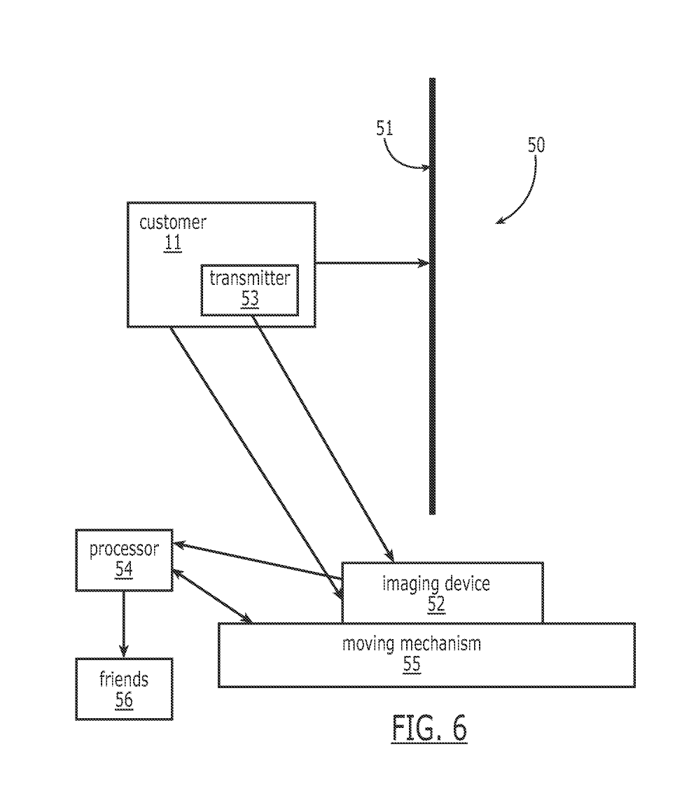

In another embodiment 50,150 (FIGS. 5 and 6), the condition (block 112, FIG. 1A) comprises a customer positioning condition. For example, the customer 11 could request (block 151) that the image be taken when the customer 11 reaches a particular location. In an example of an athletic event, the customer 11 could be competing in a foot race having a finish line 51. The imaging device 52 could be positioned so as to capture the customer's image upon crossing the finish line. In a particular embodiment, the customer 11 could be wearing or carrying a transmitter 53 (block 152) such as known in the art. The customer 11 may also elect other persons 56 to whom to send the image (block 153).

Similarly, the customer could request an image of other types of events, such as, but not intended to be limited to, a horse race, wherein the customer could request an image of a finish line of a race. Further restrictions could be imposed as desired, such as only receiving and paying for an image if the customer's selected horse wins the race. Likewise, an image could be requested of any third-party entity competing in an athletic or other contest, such as automobile racing, or of specific events during a contest, such as a selected person batting, completing a pass or making a touchdown in football, scoring in basketball, or making a soccer goal. One of skill in the art will appreciate that the situations in which the present invention can be employed are virtually limitless.

In order to make the process automatic and customer-specific, intermittent and continuous embodiments are provided (block 154). For the intermittent embodiment, the transmitter 53 is used to trigger the imaging device 52 when the finish line 51 is crossed (block 155). A similar process obtains video, wherein a predetermined length of video could be triggered to be captured upon receipt of the customer's signal, and could, in some embodiments, “lock on” to the customer in motion, wherein the imaging device 52 is automatically movable under processor 54 controls via a moving mechanism 55. Other modes of recognizing the customer 11 may also be contemplated by one of skill in the art, such as, but not intended to be limited to, biometric means, such as facial recognition.

For the continuous embodiment (block 154), the imaging device 52 is operating substantially continuously between two predetermined times (block 156), for example, in the case of a foot race, from a time prior to a shortest possible completion time to after a predetermined longest completion time. Another possible location for such imaging would be during a parade, wherein the parade route and time span are fixed (e.g., a city or a theme park) and pre-determined, thereby permitting imaging devices 52 to be positioned along the parade route and activated during the time of the parade, with perhaps additional time spans scheduled prior to and/or after the event to capture crowd shots. In these cases, either after or during the event, customer recognition is performed (block 157) at the predetermined position (e.g., the finish line 51 or a specific city block location for the parade embodiment), and the image containing the customer 11 is mapped to the previously obtained customer data (block 158) or to the city block identified. Remaining images are stored (block 159) in the event that, after the event, even those who have not pre-ordered could provide their data and obtain an image later.

Since there may be an inherent delay in the initiation of video capture from the “start” signal, the capture delay can be compensated for by retaining a video sequence prior to the receipt of the signal. This delay can be adjustable, if the event is repeatable and a substantially known time period, or can be set at a predetermined amount, such as a second or less. For example, if the target is in motion, and a capture sequence is initiated during the motion, the video sequence prior to the start signal could include material desirable to the customer, and would thus be beneficial to retain and include in the clip provided. In addition, for manual capture, a time code could be sent from the customer communication device to inform the system of any delays that might be occurring because of traffic or other considerations.

The remaining processing and transmitting steps can be substantially as discussed above (block 160). In addition, if an option has been exercised to send the image to friends (block 161), the image can be transmitted to them 56 as well (block 162), thereby adding not only wide and automatic distribution potential, but also eliciting an immediacy to the transmission, since it can be substantially simultaneous with the event and contemporaneous with the transmission to the entire distribution group. The customer 11 can also be contacted within a predetermined time after the event and have the image displayed on the communication device 13 automatically, such as 15 minutes after completing a marathon. Manipulation of the image can be automatically performed suitable to the event as well, such as merging the image with a pre-recorded background or video clip (e.g., a sports-related commercial, cheering crowds, etc.) This embodiment could be useful for many types of situations, such as, but not intended to be limited to, during skiing, rafting, or any other outdoor or indoor activity. In the parade embodiment, the customer 11 could order an image even after the event by identifying his/her position along the parade route and selecting from among images taken of that position.

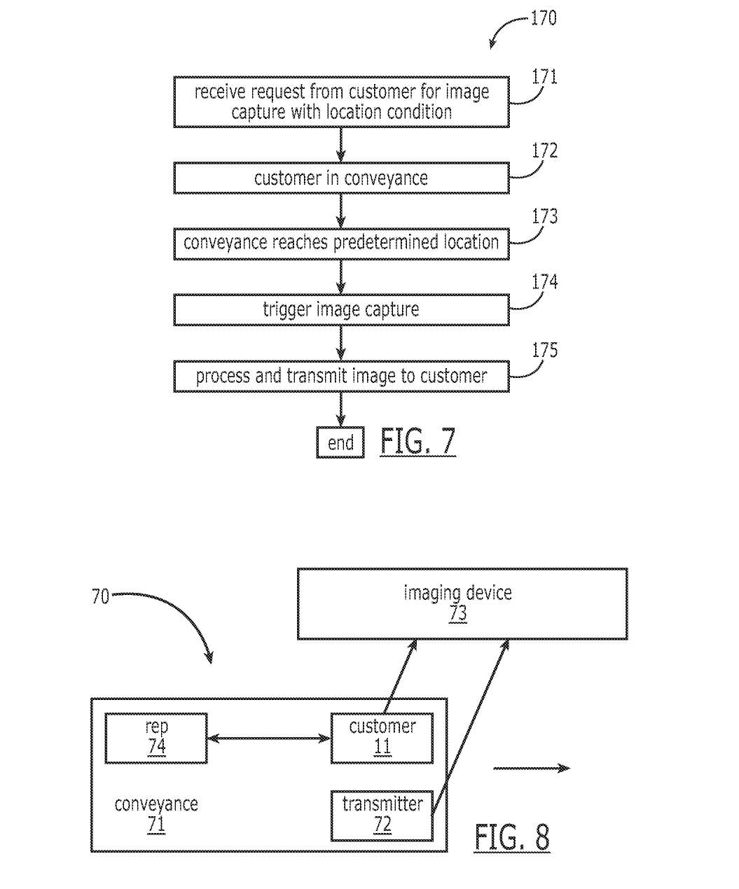

In yet another embodiment 70,170 (FIGS. 7 and 8), similar in some ways to the preceding one, the condition (block 112, FIG. 1A) comprises that the customer 11 can request that an image be captured (block 171) while positioned in a conveyance 71, for example, an amusement ride or a carriage (block 172). The image capturing step could be, as above, intermittent or continuous. In the intermittent case, the image capturing can be triggered by a transmitter 72 that in this embodiment can be affixed to the conveyance 71 so that, when the conveyance 71 has reached a particular location (block 173), an imaging device 73 is triggered to capture the image (block 174). In this embodiment, the requesting step could be performed, for example, through a human representative 74 such as a leader or conveyance driver, who could earn a commission for each image sold. The continuous embodiment could operate as above, with, again, a commission paid to the human representative 74 for each image sold. The resulting image could be made available on-site or subsequently, and processed and transmitted as above (block 175).

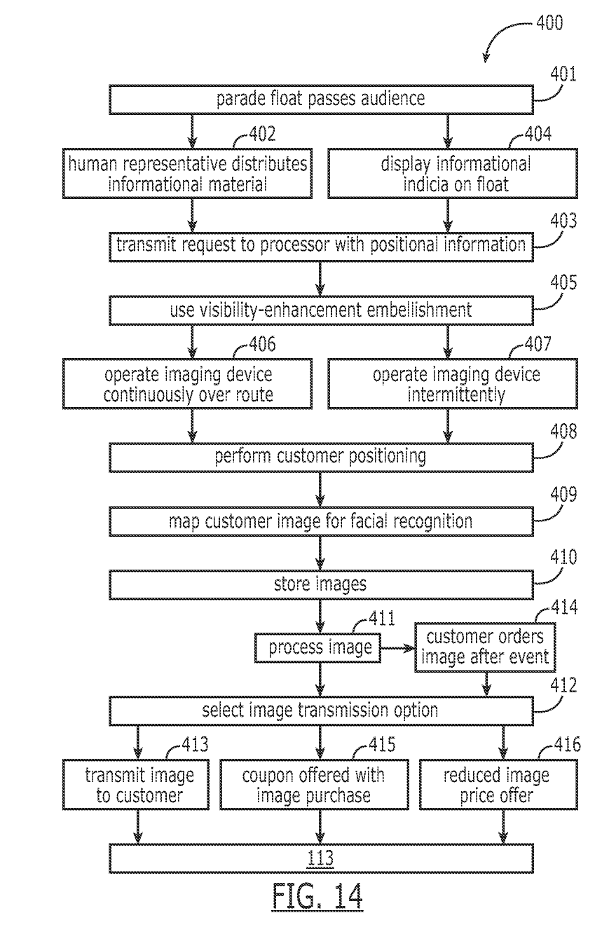

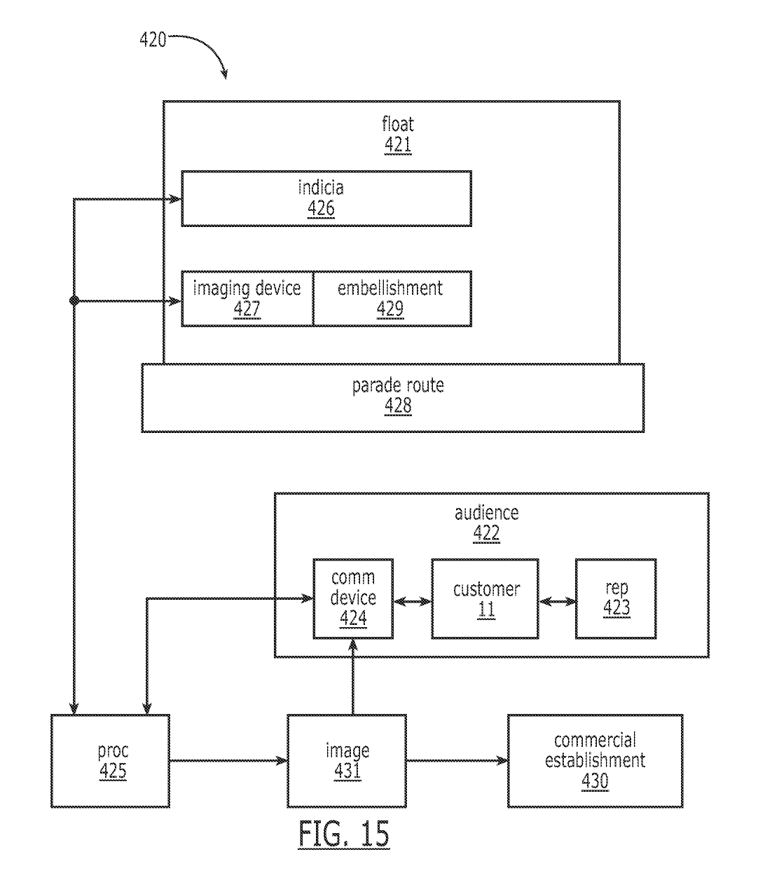

In another embodiment 400,420 (FIGS. 14 and 15), the condition also comprises a customer positioning condition (block 112, FIG. 1A), wherein the position comprises the customer's presence at an event such as a parade, with a moving object such as, but not intended to be limited to, a float 421 passing an audience 422 (block 401). In an embodiment, a human marketing representative 423, who may be in costume, for example, can mingle with the audience 422, generating enthusiasm and distributing informational material regarding a procedure for requesting an image to be taken at the customer's position (block 402). Such a procedure can comprise, as above, using a communication device 424 to transmit a request to a processor 425 with a location (block 403).

In another embodiment, the float 421 can have indicia 426 thereon with the informational material regarding the request procedure (e.g., “Text #555 to request a photo of yourself at the holiday parade!” block 404).

The float 421, or another element moving with the parade, can have associated therewith an imaging device 427 in signal communication with the processor 425. As above, the imaging device 427 can comprise any means known in the art, such as, but not intended to be limited to, a still camera or a video camera. Preferably the imaging device 427 comprises a high-resolution device. The imaging device 427 can also comprise a plurality of imaging devices, for example, one mounted on either side of the float 421 for imaging both sides of the parade route 428. The plurality of imaging devices 427 can also comprise an array thereof, acting in concert or independently.

The imaging device(s) 427 can also have enhanced visibility or have some other attention-getting embellishment 429, to attract the customer's attention to improve the image (block 405). Such an embellishment can comprise elements like flashing lights or a count-down clock, for example.

In an embodiment, the imaging device 427 can be operating substantially continuously between two predetermined times (block 406), for example, while the float 421 is traveling along the parade route 428. Alternatively, the imaging device 427 can be activated only at those locations at which a customer 11 has requested an image (block 407). In either case, either after or during the event, customer positioning can be performed (block 408) with reference to the customer's supplied data (e.g., a specific city block location), and the image containing the customer 11 is mapped to previously obtained customer data (block 409) or to the city block identified. Some or all of the images can be stored (block 410) in case, after the event, even those who have not pre-ordered could provide their data and obtain an image later.

The image can be processed (block 411), and the customer 11 can decide from among a plurality of transmission options (block 412). In one option, the image can be transmitted directly to the customer 11 (block 413) as described above. The customer 11 could also order an image even after the event by identifying his/her position along the parade route and selecting from among images taken of that position (block 414).

In other embodiments, commercial advantage can be gained by establishing a nexus between the customer 11 and a commercial establishment 430. The commercial establishment 430 can comprise virtually any entity that provides goods and/or services, such as, but not intended to be limited to, retail establishments, restaurants, and service providers such as salons or theatres. Here an option can be offered to pick up the requested image 431 at the commercial establishment 430 (block 415), with an incentive of a coupon, discount, or free item offered to the customer 11. Alternatively, the image 431 could be provided free of charge, or at a reduced rate, if the customer 11 shops at the commercial establishment 430 and spends at least a predetermined amount there (block 416).

Depending upon which options are selected, the method 400 can proceed as from block 113 of FIG. 1A, with some or all of the following steps (FIGS. 1A and 1B).

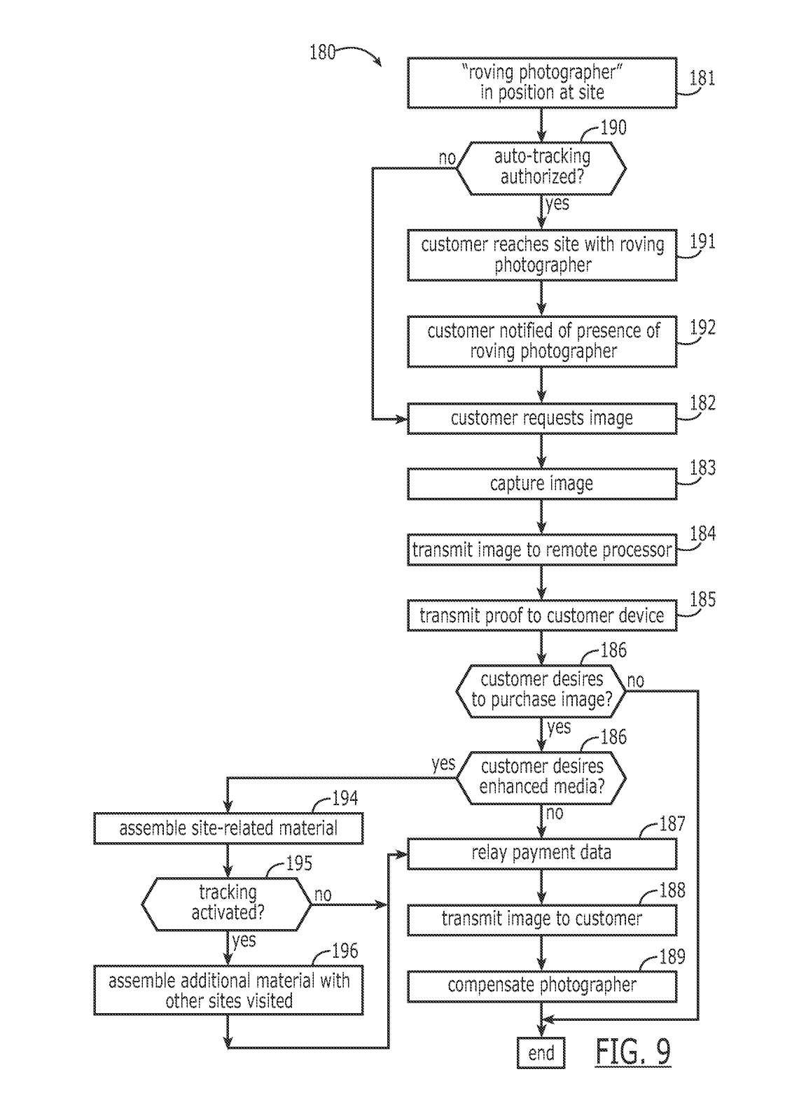

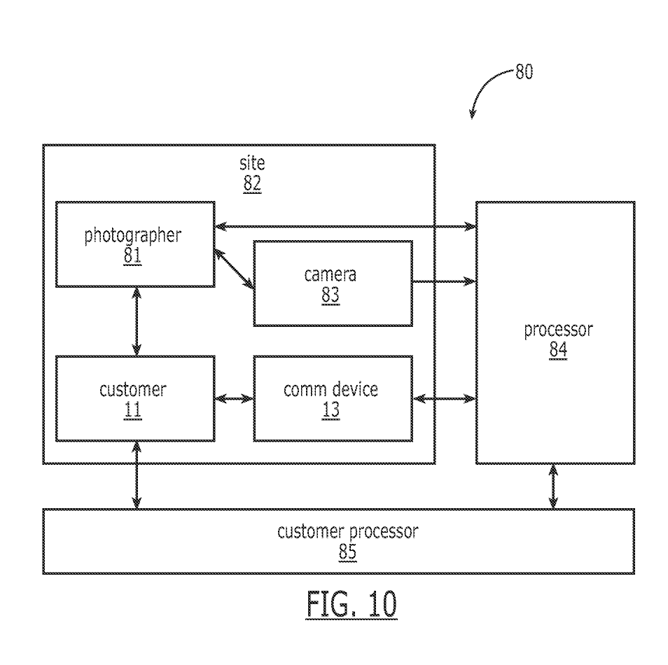

In a further embodiment 80,180 (FIGS. 9 and 10), a “roving photographer” 81 is present at a site 82 visited by the customer 11 (block 181). In this embodiment of the method 180, a request may have been received from the customer 11 to engage auto-tracking as above (block 190). When the customer reaches a site where a roving photographer 81 is present (block 191), the customer 11 is automatically notified (block 192). A request can be received from the customer 11 by the photographer 81 for an image to be taken of the customer 11 at the site 82 (block 182). The image is captured 83 (block 183) and transmitted to a remote processor 84 (block 184). A proof image of the image is transmitted from the remote processor 84 to the customer's communication device 13 (block 185), which can occur substantially contemporaneously with the image-capturing step at the site 82.

If the customer 11 decides to purchase the image (block 186), it is then determined whether the customer 11 desires an enhanced media output as above (block 193), in which case site-related and other media are assembled (block 194). If tracking has been activated (block 195), additional media as desired are also assembled, as described above (block 196).

The transaction is finalized by relaying payment data from the customer 11 to the remote processor 84 (block 187), and a final image is transmitted image to the customer 11 (block 188), such as over a network (e.g., the Internet) to a customer processor 85. In his scheme, the photographer 81 receives compensation for the transaction (block 189).

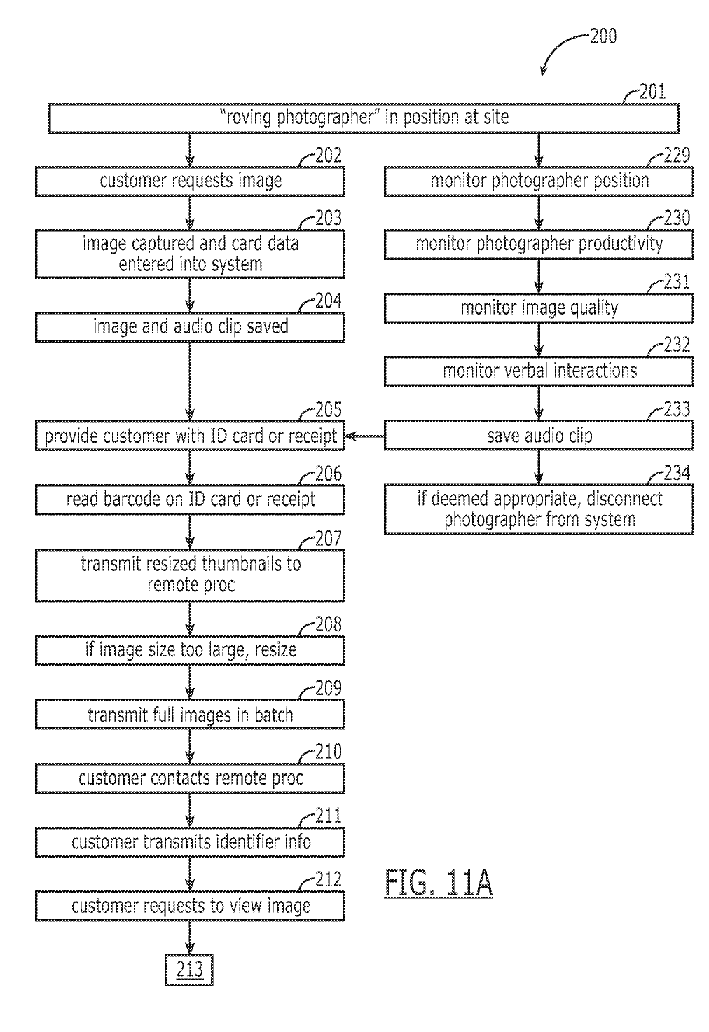

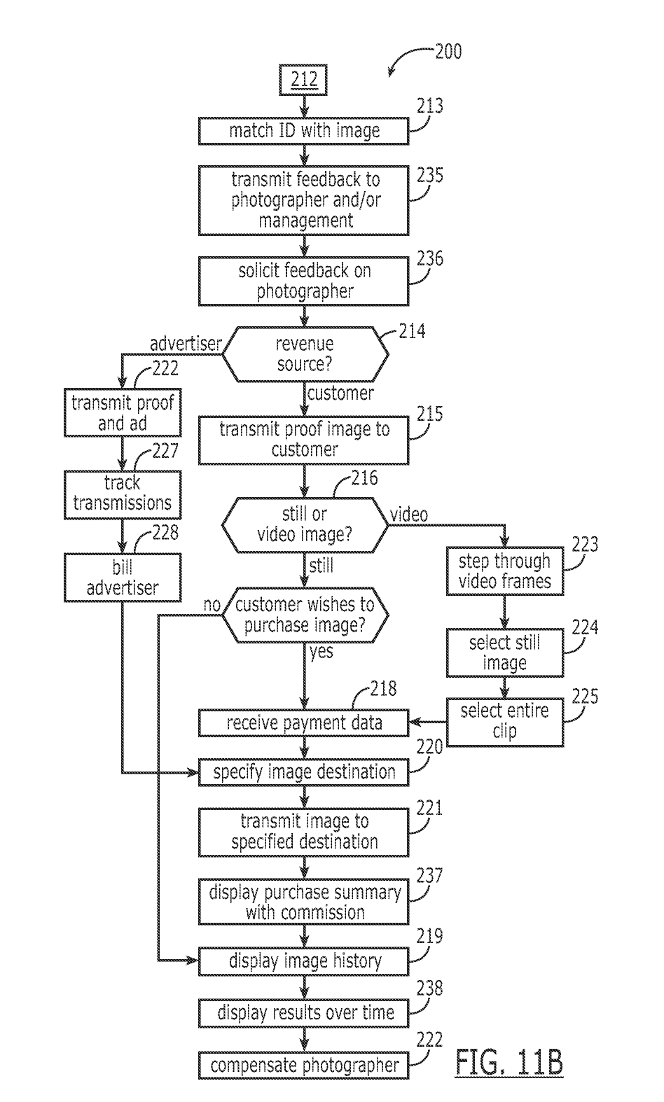

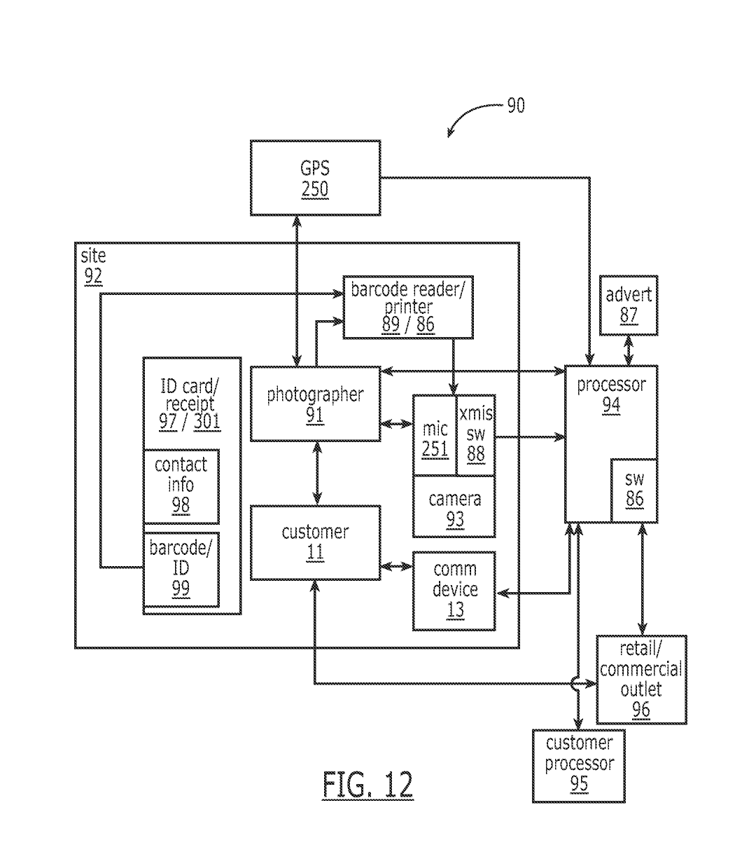

In another embodiment of a method 200 for distributing a digital image of a customer a “roving” photographer 91 is again used at a site 92 (block 201; FIGS. 11A, 11B, and 12). The photographer 91 can have received particular training in the method 200 and be equipped with equipment specific to the method 200, such as camera, computer, requisite cords, wireless Internet access, and the like. This embodiment 200 comprises the step of receiving a request from the customer 11 to the “roving” photographer 91 for an image to be taken of the customer 11 at the site 92 (block 202). Again, the “roving” photographer is equipped with a camera 93, which may comprise a digital still camera or a digital video camera or other digital imaging device that is able to access a remote processor 94, such as over the Internet via WiFi or some other system. An image or a plurality of images of the customer 11 is captured at the site 92 in response to the received request (block 203). Also captured, for quality control, is an audio clip of at least a portion of the photographer's interaction with the customer 11, and at least a portion of the audio clip is saved along with the image (block 204). The image(s) can comprise, for example, a digital still image or a digital video image comprising a sequence of frames, which will be discussed further in the following. Image card information is put into the system just before or immediately after an image is captured, but before the card is distributed to the customer. Resizing will take place for the thumbnails.

In a particular embodiment, herein presented by way of example only, the photographer 91 is equipped with a stock of coded cards 97 and a barcode scanner 89. Alternatively, the photographer 91 could print his/her own cards 97 after accessing the Internet to obtain unique indicia therefor. A customer 11 is given a card 97 having thereon indicia such as contact information 98 for ordering and retrieving photographs, such as telephone number and/or website, and unique identifier information such as, but not intended to be limited to, a barcode 99, QR code, or the like (block 205). Prior to giving the card 97 to the customer 11, the photographer 91 can use an identifier detector, such as the barcode reader 89, to swipe the card's barcode 99 into the system. One of skill in the art will recognize that a plurality of identifier means could be used in the system 90, such as radio frequency identification or other means known in the art. If the embodiment using the printer 86 is used, there is no need to read in a barcode.

In an alternate embodiment, the system includes a subscription option, wherein the customer 11 can become a member of the imaging organization, with membership privileges. Membership privileges could include, for example, receiving some or an unlimited number of images for a predetermined time period, some or an unlimited number of images at a predetermined location, or some other permutation thereof. In this case, the customer 11 could be provided with a “permanent” card 97 with his/her unique identifier information. Further, a subscriber could use an associated website to automatically send images to a group of friends or family, to automatically route images for printing to a specified location, or any other preference known in the art.

Once the photographer 91 has completed the image-capture process, the barcode reader 89 (block 206) triggers via, for example, embedded software 88, the imaging device 93 to transmit the image(s) and the identifier data via a network 87 such as the Internet to a remote processor 94 under control of the imaging organization. The camera 93 can be equipped, for example, with WiFi capability for transmitting directly to the Internet. Alternatively, a separate device may be employed.

In yet another embodiment, the photographer 91 could have a portable printer 86 provided that can print on demand a receipt 301 to take the place of the card 97. The photographer 91 can use the printed receipt 301 as a trigger for transmitting images as above. A proof image may be printed as the receipt.

In a particular embodiment, the image(s) can be uploaded in two steps: First, a limited-data-set version of the image (a “thumbnail”) is transmitted (block 207), since this process can occur quickly.

Then, the full-data-set image is prepared for transmission. The transmission software 88 can also be adapted to ascertain the image size, in case the photographer 91 has set the camera 93 settings incorrectly and the image size is too large. In this case, the transmission software 88 can automatically resize the image for efficiency of transmission (block 208). The full images can then be transmitted, in an embodiment, in a batch (block 209), which will typically take longer, and may require queuing. If desired, management could monitor the quality of the photographer's work by viewing the thumbnail images, which will be discussed further in the following.

The customer 11, using the contact information 98, can then contact the remote processor 94 having software 86 resident thereon for mediating the following transactions (block 210) and transmits the identifier information 99 (block 211). The identifier information 99 can be transmitted via a telephone keypad, for example, or via barcode or other indicia recognition on a telephone equipped with a camera. Alternatively, facial recognition software could be used to automatically identify the customer 11.

The customer 11 can have provided his/her own preferred method of being contacted or making contact. In one embodiment, the customer 11 can make a request to view the image(s) (block 212); the identifier information 99 is matched to the image(s) (block 213).

The customer 11 may if desired provide feedback on the photographer 91 (block 235), whether or not an image is ultimately purchased. Such feedback can be transmitted to the photographer 91 and/or the processor 94 for collecting photographer data (block 236) for use by a management entity, for example.

In terms of at least part of the revenue source being the customer (block 214), a proof image is transmitted from the remote processor 94 to a customer device 13 (block 215), which, as above, can include a cell phone, a computer, or any type of web-connectable device.

Preferably the image cannot be retained by the customer 11 at this point, nor can the customer 11 transfer the image in any way, and it will disappear after a predetermined amount of time. In another embodiment, the customer 11 can be automatically sent a text message or email containing a QR code, barcode, or the like for a link to the site at which the image(s) can be located.

If the customer decides to purchase a still image (blocks 216,217), a transaction is finalized by receiving payment data from the customer 11 (block 218); if the customer does not desire to purchase the image (block 217), the process terminates (block 219). If the image is purchased, and payment is validated, the customer 11 can indicate where the final image should be sent (block 220). Exemplary customer selections can include, for example, the customer's own device, such as the mobile device 13 or a home computer 95, or a device of another party, such as, but not intended to be limited to, a friend or family member. Images can be sent to multiple devices as desired. The system 10 will automatically size the image commensurate with the device to which the image is being sent. If the customer 11 is a member, for example, a default customer preference may dictate that the image always be sent to a predetermined location.

Alternatively, the image can be sent to a commercial outlet 96 that is equipped to print or otherwise make an electronic copy of the image for subsequent pick-up by the customer 11. A map location and contact information may be relayed to the customer. This option can be attractive, for example, during travel, wherein the commercial outlet 96 can comprise a retail store that has photographic printing equipment, or a specialized kiosk situated in a hotel, or any other location accessible by the traveler. Once the customer selection is made, the final image is transmitted to the desired location (block 221). The image could also be made available through a third-party website that could be paid for such a service, for example, a retail website. Further, a human intermediary could be used to transmit the image to any Internet-connected printer, after having received instructions from the customer 11 to do so. In addition, the image could be transmitted to one or more online social networking or image-sharing sites, such as, but not intended to be limited to, Facebook, Flickr, or Twitter.

As discussed above, an option to request a complete album can be provided, wherein the customer's own images can be formatted into a unified whole, with or without the addition of library images, for example, of the location at which the images have been taken. If GPS data are provided, the customer's images can be automatically inserted into the album with the stock images. As will be understood by one of skill in the art, the “album” could take the form of a physical entity or an electronic file. Text information may also be included.

The photographer 91 can receive compensation as a commission on sales, for example. The photographer 91 can be notified with a purchase summary and a copy of the image, indicating a commission, for example (block 237). When the image is uploaded with the identifier data, those data are associated with the photographer 91. Then, when the customer 11 makes payment, the photographer's commission can be credited to his/her account, or loaded onto a debit card, for immediate or subsequent disbursal via means known in the art (block 222). The photographer 91 can also, if desired, view a historical record of the images taken (block 219), along with the results experienced (block 238), a tool that can help the photographer 91 hone his/her technique and improve connectedness to the system.

As discussed above, the image can comprise a digital still or video image (block 216). If the image is a video clip, the proof comprises at least a portion of the video clip, and the customer 11 can step through the video clip frame by frame (block 223) to select one or more still images therefrom (block 224), and/or he/she may elect to purchase the entire video clip (block 225). The video clip could be provided as an event memento, such as at a wedding to the guests.

In an alternate embodiment of this system 90, rather than, or in addition to, soliciting payment from the customer 11 for a final image (block 214), revenue is generated at least in part by advertising. Here, along with the proof image, an advertisement in the form of a still image and/or a video clip is sent to the customer communication device 13 (block 226), or a Web link. Payment can be received from the advertiser 87 by, for example, tracking the number of times the advertisement is transmitted (block 227), and billing the advertiser at a predetermined rate therefor (block 228).

Various types of monitoring can be carried out by the management entity, for quality control and coverage, for example. If a GPS sensor system 250 is in place, the position of the roving photographer 91 could be monitored at least some of the time (block 229). The photographer's efficiency and success rate can also be monitored (block 230) by calculating the number of image captures and cards scanned, which will give an idea of the photographer's productivity. The management entity can track a plurality of photographers in real time, and also ensure that a particular area is not over- or under-covered by photographers, and that each photographer is within a predetermined area. As stated above, the photographer's image quality can also be monitored (block 231) by checking some proportion of the thumbnails transmitted by the photographer. Audio clips 251 can also be transmitted and monitored (block 232) to ensure acceptable customer interactions. Management may also have the capability of listening to the photographer in real time via a microphone 251 in or associated with the camera 93.

In a particular embodiment, audio clips can be captured and randomly sampled to monitor the photographer's procedures. A particular length of clip, for example, one minute, can be continuously retained. Once an image is captured (block 203) and saved (block 204), at least a portion of the audio clip is linked to the image (block 233), such as 30 seconds prior to and 30 seconds after image capture. This procedure will give management the opportunity to not only monitor the photographer, but to investigate any complaints that might be received from a customer. Such clips can also be used as training tools, whether they are good or bad examples.

If such monitoring is in place (blocks 229-233), the remote processor 94 preferably also has the ability to disconnect the photographer 91 from the system 90 if deemed appropriate, which can be an important feature, especially in public places (block 234).

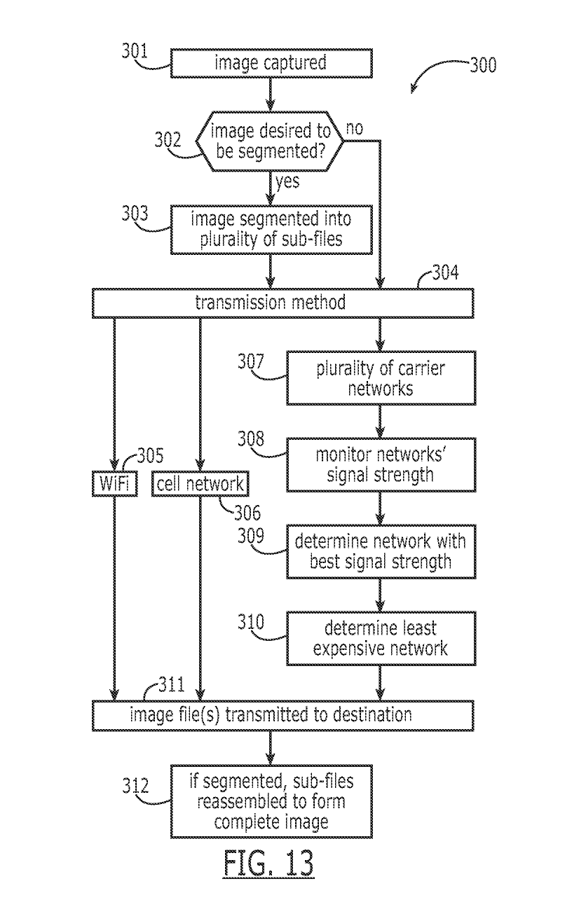

Depending upon location and other factors, it may be desirable to use a method to ensure that the integrity of the signal carrying the image is maintained during delivery to its desired location. To that end, a method 300 (FIG. 13) can be provided having various alternative embodiments for transmitting the image to a remote location.

Once the image is captured by whomever or whatever is operating the system (block 301), it may be desirable to segment the image into smaller sub-files in order to lessen the chance that the file be corrupted during transmission (block 302). Such corruption could conceivably occur for reasons of bandwidth issues and/or signal reception, and a smaller file would have a smaller chance of being interrupted than a larger file. If this option is selected, the image is then segmented into sub-files (block 302).

Various considerations can determine the transmission method/medium for the image (block 304). For example, if available, WiFi (block 305) may be deemed most effective, or a cell network (block 306).

Another method, which would be mediated by a processor with an algorithm installed thereon, would include the use of a plurality of carrier networks (block 307). The multiple-carrier option would likely improve the chances that an adequate signal be available to carry the image. In some instances, the algorithm could monitor the signal strengths of each of the carrier networks (block 308) and select the network with the highest strength (block 309) over which to transmit the image. Alternatively, or in addition, the algorithm could calculate the network with which is associated the lowest cost (block 310) and select that network.

In whatever method is used, the image file is transmitted to the selected destination (block 311). If the file had been segmented prior to transmission (block 303), it is then reassembled in order to form a complete image file (block 312).

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

That which is claimed is:

1. A method for distributing a digital image of a customer at a site, the method comprising:
selecting a site;
locating a customer at the site;
requesting a digital image of the customer at the site;
capturing the digital image;
transmitting the digital image to a processor;
viewing the transmitted digital image;
authorizing transmission of the digital image to a communications device by the customer;
approving the authorized transmission; and
transmitting the digital image to the communications device in response to the approval.
